(19) United States
(12) Patent Application Publication
(10) Pub. No.: US 2026/0099138 A1
(43) Pub. Date: Apr. 9, 2026

(54) AUTOMATED ASSIGNMENT OF RESOURCES FOR WELLBORE SERVICING OPERATIONS

(71) Applicant: Halliburton Energy Services, Inc., Houston, TX (US)

(72) Inventors: K V V N Krishna Babu Yerubandi, Duncan, OK (US); Kevin Paul Miller, Grand Junction, CO (US); Ernst Rudolf Manfred Schnell, Houston, TX (US); Anoop Sheshrao Jogdand, Pune (IN); Siva Rama Krishna Jandhyala, Houston, TX (US); Nachiket Hemant Gokhale, Pune (IN)

(21) Appl. No.: 18/906,714

(22) Filed: Oct. 4, 2024

(51) Int. Cl. G05B 19/418; E21B 21/08; E21B 44/00

(52) U.S. Cl. CPC G05B 19/41865; E21B 21/08; E21B 44/00; G05B 19/4185

(57) ABSTRACT

A method for assigning resources for wellbore servicing operations includes receiving information on jobs including resource requirements of the jobs and predicted timing of the jobs, receiving information on resources, and generating a forecast sequence of operations in which at least some of the resources are assigned to at least some of the jobs for respective periods over a window of operation. The forecast sequence of operations optimizes for efficient allocation of the resources by passing constraints regarding ability of the resources to deliver the respective jobs in time while minimizing a cost function. The method further includes outputting the generated optimized forecast sequence of operations for confirmation and communication of the assignments.

### BACKGROUND

Marshalling resources to serve a number of upcoming oilfield operations depending on the work progress of a number of independently working drilling rigs is a non-trivial task requiring frequent review and adjustment of the plan ahead and the associated assignments for resources. Commercial operations require the efficient use of the capital and cost bound in the assigned resources, adding optimized utilization to the task. The system and method of the present disclosure may address one or more of these issues.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic diagram of a cloud-based telemetry data collection system, according to an embodiment of the present disclosure;

FIG. 2 is a schematic diagram of a sequence predictor, according to an embodiment;

FIG. 3 is a schematic diagram of an exemplary filled blend sheet, according to an embodiment;

FIG. 4A is a schematic diagram of assignment of example resources to example jobs, according to an embodiment;

FIG. 4B is a schematic diagram of assignment of example resources to example jobs, according to the embodiment of FIG. 4A;

FIG. 5A is a schematic illustration of geographical locations of jobs, according to an embodiment;

FIG. 5B is a schematic illustration of an assignment of resources to jobs, according to the embodiment of FIG. 5A;

FIG. 6A is a schematic illustration of geographical locations of jobs, according to another embodiment;

FIG. 6B is a schematic illustration of an assignment of resources to jobs, according to the embodiment of FIG. 6A;

FIG. 7A is a schematic illustration of geographical locations of jobs, according to yet another embodiment;

FIG. 7B is a schematic illustration of an assignment of resources to jobs, according to the embodiment of FIG. 7A; and

FIG. 8 is a flow diagram of a method for assigning resources for wellbore servicing operations.

### DETAILED DESCRIPTION

It should be understood at the outset that although illustrative implementations of one or more embodiments are illustrated below, the disclosed systems and methods may be implemented using any number of techniques, whether currently known or not yet in existence. The description that follows includes example systems, methods, techniques, and program flows that embody aspects of the disclosure. However, it is understood that this disclosure may be practiced without these specific details. For brevity, well-known steps, protocols, structures, and techniques have not been shown in detail in order not to obfuscate the description. The disclosure should in no way be limited to the illustrative implementations, drawings, and techniques illustrated below, but may be modified within the scope of the appended claims along with their full scope of equivalents.

As used herein, the term “wellbore servicing operation” means any operation related to servicing a wellbore, including but not limited to placing equipment into or proximate to a wellbore, retrieving equipment from a wellbore, pumping compositions into a wellbore, recovering compositions from a wellbore, drilling operations, completion operations, cementing operations (e.g., onshore/offshore, forward and reverse, foam/unfoamed jobs), fracturing operations, primary hydrocarbon recovery operations, enhanced hydrocarbon recovery operations, mixing fracturing fluid, mixing cement, and placing lighting equipment.

In some embodiments, the system of the present disclosure interacts with a data model of the currently known state of operations, the expected sequence of upcoming operations and data on the available resources, their status, location, current assignment and regulatory or other policy constraints. A sequence predictor tool may analyze the requirements against the available resources and create a forecast sequence of operations with resource assignments, which may optimize the resource utilization over the timeframe (e.g., 1-2 weeks). Based on this optimized sequence, the system may suggest assignment options to a coordinator to realize the optimized sequence of operations. The forecast sequence may be frequently updated to consider actual developments and progress of operations.

An asset-to-cloud system may create a telemetry path and repository for geolocation, job data, and status data for deployed surface equipment (e.g., pumping equipment, bulk equipment & foam equipment, batch mixers). A data model and user interface may allow coordinators to make and communicate resource assignment decisions for their area of operations. A sequence predictor may optimize assignments of resources to jobs. Outside the project, data on staff, competency and operational and regulatory constraints for assignments may be used to achieve the optimization.

In some embodiments, an artificial intelligence (AI)/machine learning (ML) component may learn the patterns of lead times, travel duration, job duration and other inputs and provide a more accurate prediction of future event, from which assignment option are generated. The human coordinator may be the final decisionmaker for adding a sense check and allows consideration of experiential factors not captured in the Al/ML model.

In some embodiments, allocation of surface equipment/resources is optimized for time and cost. Given a predetermined job line up (e.g., time of job, duration, location, travel time, equipment/resource needs) and available equipment/resources, an optimization problem may be generated with the goal of maximizing resource utilization and while meeting the constraints. Mixed integer programing (e.g., a type of mathematical optimization problem where some decision variables are required to be integers, while others can be continuous) can be used to program and solve the optimization problem to generate the best combination of equipment/resource allocation.

The specific instances of mixed integer programming may take the form of mixed integer programs (e.g., a class of optimization algorithms in which some (or all) of the variables are allowed to be integers as opposed to real numbers). This restriction may dramatically increase the complexity of mixed integer programming algorithms as compared to real-valued continuous optimization problems. In fact, mixed integer programs are NP-complete and the algorithmic complexity is typically exponential in the number of variables. For small problems, brute force solution (generating all combinations of decision variables) and calculating the cost for each can be a feasible solution strategy, especially when combined with parallel computing resources. But, due to the exponential complexity, this may quickly become infeasible as the number of decision variables increases, because the computational cost increases very rapidly. This may necessitate the use of heuristic methods to solve integer programming problems. The method of the present disclosure may include using heuristic methods such as (1) branch and bound, in which regions in decision variable space which cannot contain the solution are eliminated and not searched; (2) tabu search, in which an integer constrained variable can be changed while keeping the other integer constrained variables constant; (3) hill climbing, in which one starts with a feasible solution and attempts to improve it; and/or (4) simulated annealing, which is a probabilistic method in which the decision on whether to move to a new state from the current state is decided probabilistically. Any one or more of these techniques can be used in the method for assigning resources for wellbores service operations (e.g., the forecast sequence of operations may be generated using any of the mixed integer programs described herein).

For example, pump trucks may be allocated to a sequence of jobs based on time/travel constraint using the following steps: (1) Obtaining a list of jobs available for execution in a given ‘Window of Operation’ and number them in sequence (1 to nJ) where nJ is the number of jobs; (2) Obtaining the location, start time of the job and resources need to execute job; (3) Obtaining information regarding the available pump trucks at the operation's disposal and numbering them in sequence (1 to nP); (4) Obtaining the initial location of the pump trucks; (5) Defining cost of function associated with the ‘window of operation’ where one such example is number of ‘jobs not executed’; (6) Defining at least one constraint to evaluate an execution sequence where one such example is to evaluate if all allocated jobs can have the pump truck reach the desired location in time for the execution of the job by finishing the previous allocations for the pump truck; (7) Generating a series of ‘allocations’ where not allocating a pump truck would indicate deciding not to execute the job utilizing one of many mixed integer programming for optimization; and (8) Choosing an allocation that has the lowest cost while passing the constraint(s). Although steps 1-8 are explained with reference to pump trucks for ease of understanding, these steps can be applied to match any type of resource to any type of job (e.g., hydraulic fracturing spread equipment, drilling rig equipment, coiled tubing units, workover rigs, etc.). That is, the resources may not only include pump trucks but other resources types as well, such as cementing trucks, drilling rigs, personal, etc.

In some embodiments, the cost function may be the true cost of the jobs including job volume, resource wages, maintenance and operational expenses associated with capital assets. It may also include profitability. The constraints may include resource resting time, maintenance schedules, regulatory requirements, and/or travel time constraints. Locations for the resources can be live (e.g., tracked using mobile locators). Travel time can be live or real-time to take into account road and traffic conditions.

A system for assigning resources for wellbore servicing operations may include one or more processors configured to: receive information on jobs including resource requirements of the jobs and predicted timing of the jobs; receive information on resources; generate a forecast sequence of operations in which at least some of the resources are assigned to at least some of the jobs for respective periods over a window of operation (e.g., to satisfy the resource requirements and predicted timing of the jobs), wherein the forecast sequence of operations optimizes for efficient allocation of the resources by passing constraints regarding ability of the resources to deliver the respective jobs in time while minimizing a cost function; and output the generated optimized forecast sequence of operations for confirmation and communication of the assignments (e.g., send the forecast sequence of operations to a coordinator who will make the final decision on resource allocation).

The optimizing may minimize time or distance traveled to jobs across a fleet. A display may be configured to display the generated forecast sequence of operations. For example, the display may display the generated forecast sequence of operations along with other generated forecast sequence of operation in a list. A user may select a sequence of operations from the list. The cost function may include jobs not executed and associated opportunity cost of the jobs not executed. The example, the system may determine the opportunity cost of not doing a job and use that opportunity cost as the cost function or part of the cost function. The system may take into account the overall economics of the jobs in the aggregate.

The one or more processors may be further configured to provide a user interface configured to receive user input for accepting or altering the forecast sequence of operations. For example, the user interface may present one or more options in the form of forecast sequence of operations and allow the user to select one sequence from the available options. The forecast sequence of operations may be updated in response to either one or both of the information on the jobs and the information on the available resources being updated. It may be updated, for example, every minute or every hour. The information on the jobs and the information on the resources may be transmitted from a cloud-based telemetry data collection system for deployed resources. The information on the jobs may include expected time of each job (e.g., time at which the job is expected to be performed), location of each job (e.g., geographical location), and requirements of each job. The information on the jobs may include equipment required for each job, personnel required for each job, and materials required for each job. The information on the resources may include geolocation information of the resources and status information of the resources. The information on the resources may include equipment, personnel, and material. The equipment may include bulk storage, bulk transport, pump unit, automotive, and ancillary equipment.

The constraints may include ability of the equipment to do the jobs, fitness of the equipment to do the jobs, ability for the equipment to arrive at the jobs in time (e.g., taking into account transportation time, rest time, etc.), and ability of the equipment to finish the jobs. The personnel may include one or more service leader, one or more supervisor, one or more operator, one or more bulk operator, one or more helper, and one or more bulk driver. The constraints may include qualification of the personnel to do the jobs, fitness of the personnel to do the jobs including regulatory rest requirements, ability for the personnel to arrive at the jobs on time, and ability of the personnel to finish the jobs. The material may include type of material, quantity of material, location of material, and status of material. The constraints may include whether the material is appropriate for the jobs, whether the material is of sufficient quality for the jobs, and whether the material can arrive at the jobs on time. The jobs can include well service operations including drilling operations, cementing operations, fracking operations, well intervention operations, and/or pumping operations.

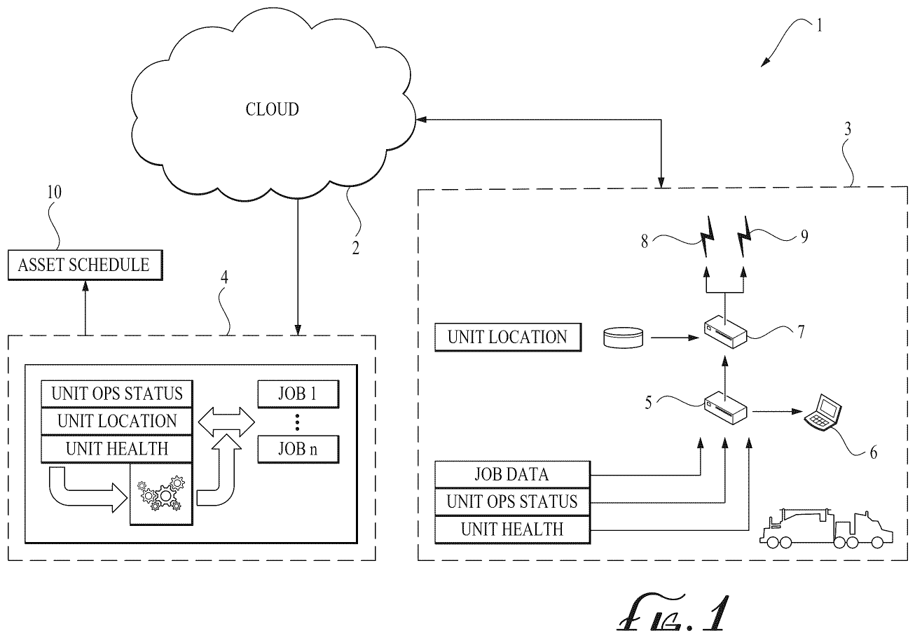

Referring to FIG. 1, a cloud-based telemetry system 1 may include a cloud 2, a communication system 3, and a coordinator 4. In the communication system 3, job data, unit operations status data, and unit health data may be collected/measured through a compact reconfigurable input/output (cRIO) 5. This data may be then sent to a modeling unit 6 at the location and/or to an edge device 7. Unit location data (e.g., from a GPS unit) may also be sent to the edge device 7. The edge device 7 may transmit the job data, the unit operations status data, the unit health data, and the unit location data via a mobile communication device 8 or a satellite communication device 9 to the cloud 2. The coordinator 4 may receive the job data, the unit operations status data, the unit health data, and the unit location data from the cloud 2. The coordinator 4 may run a sequence predictor to optimize the assignment of resources/assets to jobs. Based on this, the coordinator 4 may output an asset schedule 10. The asset schedule 10 may be used in the field to schedule real assets to real jobs.

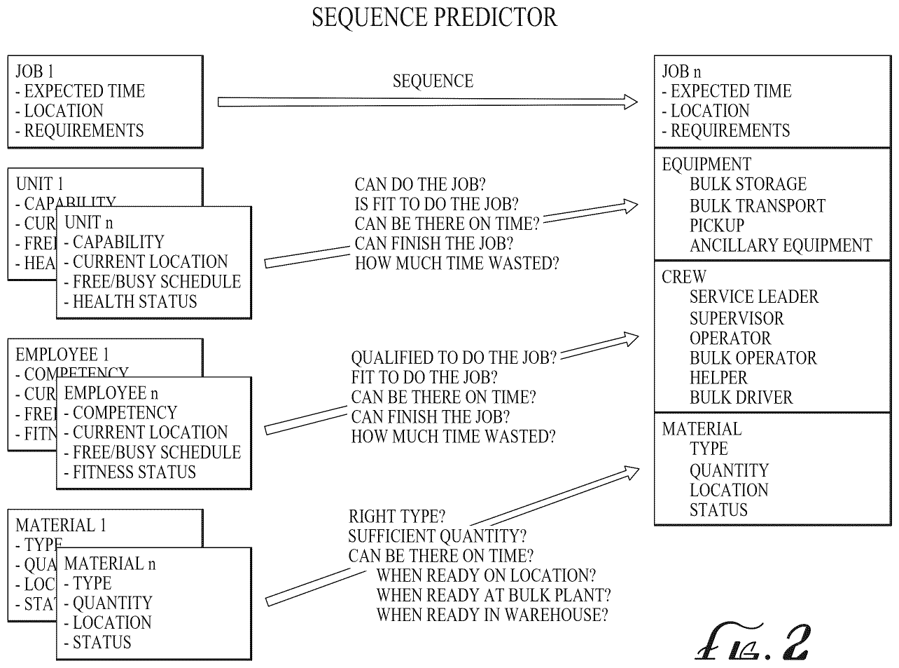

Referring to FIG. 2, a sequence predictor may generate a forecast sequence of operations in which at least some of the resources are assigned to at least some of the jobs for respective periods over a window of operation. The forecast sequence of operations may optimize for efficient allocation of the resources by passing constraints regarding ability of the resources to deliver the respective jobs in time while minimizing a cost function. For example, there may be n jobs, n units, n employees, and n materials. Each may be assigned to a job. There may be expected time, location, and requirements associated information with each job. There may be capability, current location, free/busy schedule, and health status information associated with each unit. There may be competency, current location free/busy schedule, and fitness status information associated with each employee. There may be type, quantity, location, and status information associated with each material. The equipment (e.g., unit) may be, for example, bulk storage, bulk transport, pump unit, pickup, and/or ancillary equipment. The crew (e.g., employee) may include, for example, one or more service leaders, one or more supervisors, one or more operators, one or more bulk operators, one or more helpers, and/or one or more bulk driver crew. The material may have, for example, type, quantity, location, and status information associated with it. For matching the unit to the job, the sequence predictor may consider constraints such as ability of the unit to do the job, fitness of the unit to do the job, ability of the unit to be at the job in time, and/or ability of the unit to finish the job. For matching the units to the jobs, the sequence predictor may consider amount of time that would be wasted in a hypothetical assignment as a cost function or as part of a cost function to be minimized. For matching employees to the jobs, the sequence predictor may consider constraints such as qualification of the employee to do the job, fitness of the employee to do the job, ability of the employee to be at the job in time, and ability of the employee to finish the job. For matching employees to the jobs, the sequence predictor may consider amount of time that would be wasted in a hypothetical assignment as a cost function or as part of a cost function to be minimized. The cost function may be the overall cost of the combined operations and may include opportunity cost of unutilized resources. For matching the materials to the jobs, the sequence predictor may consider constraints such as the appropriateness of the type of material for the job, whether there is sufficient quantity of material for the job, and/or the ability of the material to be at the job in time. For this question, the sequence predictor may consider when the material can be ready on location, when the material can be ready at the bulk plant, and/or when the material can be ready in the warehouse.

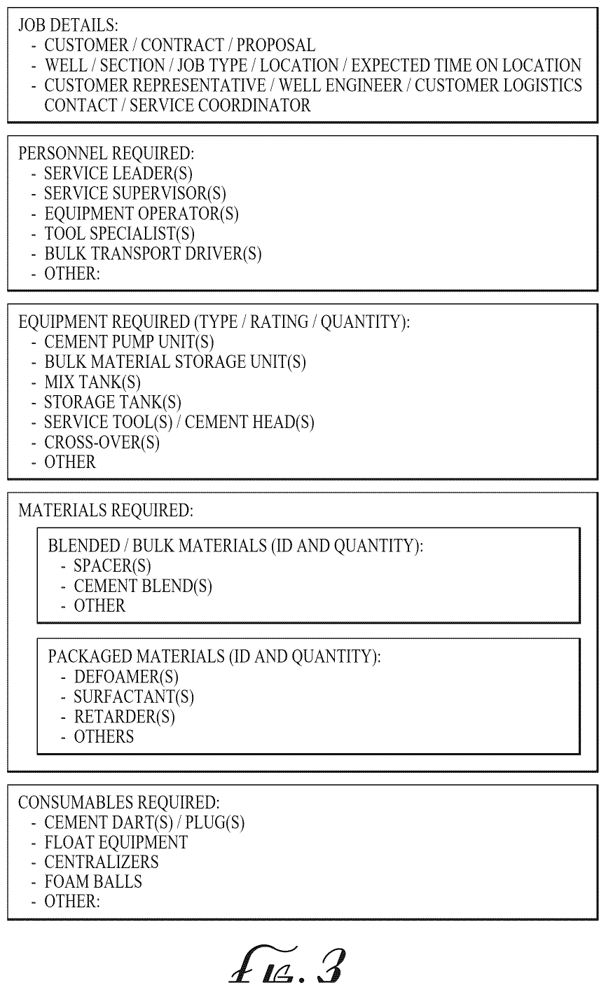

Referring to FIG. 3, the method may comprise outputting the optimized forecast sequence of operations in the form of a blend sheet. The blend sheet may be in the form of a job resource plan. The job resource plan may comprise job details, personnel required, equipment required, materials required, and consumables required. The materials required may comprise blended/bulk materials and packaged materials.

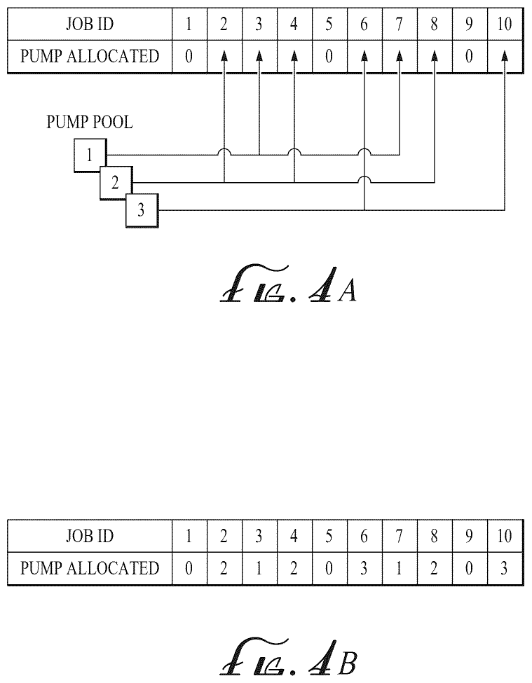

Referring to FIG. 4, the method may include generating a series of allocations of resources (e.g., pumps) to jobs using mixed integer programming for optimization. In this example, zero is used to denote not allocating any pump to a job and thus not executing the job. A series of allocations may be generated, and an allocation that has the lowest cost while passing the constraints may be chosen. The particular pump allocation may be chosen because it minimizes jobs missed (e.g., minimizes the cost function) and also passes the constraint of the pumps' ability to be transported to each job in time.

In some embodiments, machine learning forecasting enhances resource allocation using mixed integer programing. Forecasts generated by machine learning can be used as inputs to a mixed integer model (e.g., optimization model that involves both integer and continuous variables), which may allow it to anticipate and plan for likely scenarios. For example, a machine learning model may predict which jobs will require more resources and/or which resources might be constrained in the future, thus allowing the mixed integer model to optimize allocation proactively. By using machine learning to make the mixed integer model more responsive to future uncertainties, the solution may reduce costs, avoid bottlenecks, and improve overall efficiency. Machine learning may be utilized for prediction of job parameters (e.g., number of resources, time of execution) and constraints (e.g., travel time estimation, required maintenance estimation).

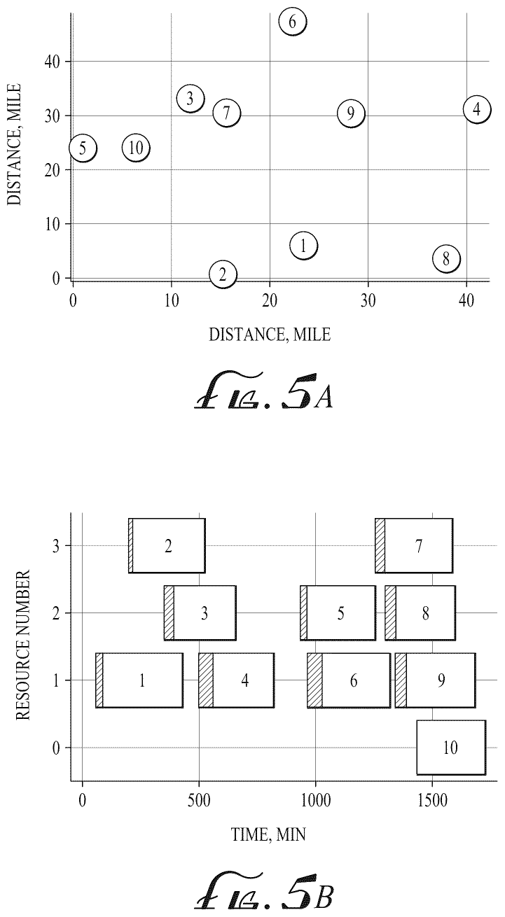

FIG. 5 shows an example in which the sequence predictor is applied to ten jobs, wherein the ten jobs are spaced apart over a geographical area. The jobs may be available for execution in a window of operation. Location, start time of the jobs, and resources needed to execute the jobs may be acquired. Initial locations of the resources may also be acquired. In this example, a cost function may be defined based on jobs not executed. The cost function may alternatively or additionally be based on profitability of the jobs, efficiency of the pumps, cost of the resources, etc. Constraints may be defined based on ability of the resources to arrive at the jobs in time (e.g., to perform the jobs). The constraints may also include rest periods, break times, and/or maintenance schedules of the resources. Based on the constraints, a series of allocations may be generated matching specific resources to the jobs at various times. Among the series of allocations, the allocations with the lowest cost function may be selected. In this example, the lowest cost function was associated with one job not being executed (i.e., job 10). In this example, job 10 is matched with “resource 0” to signify that no resources have been assigned to it. The remaining jobs 1-9 were assigned resources 1-3 at certain times which take into account travel time (i.e., shaded area on the left of the boxes in the graph signify travel time).

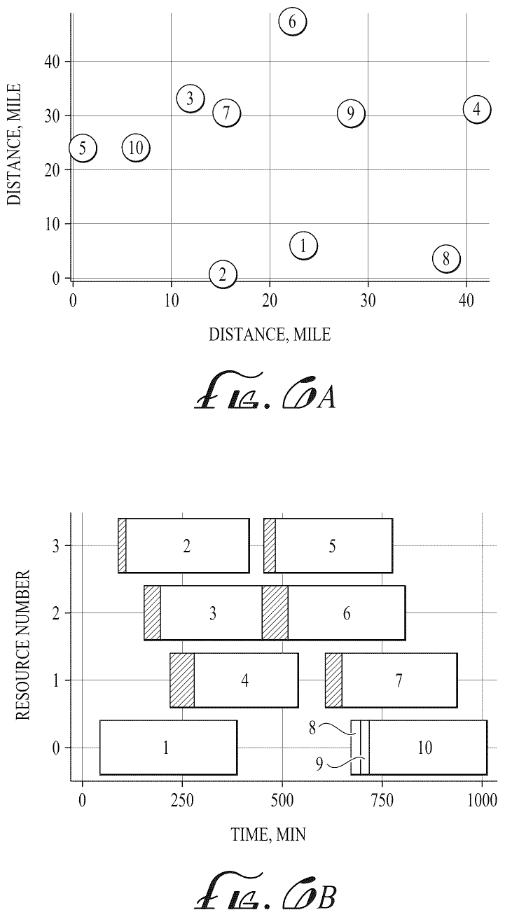

FIG. 6 shows another example in which the sequence predictor is applied to ten jobs, wherein the ten jobs are spaced over a geographical area. In this example, the allocation among the series of allocations with the lowest cost function involves four jobs being missed: job 1, job 8, job 9, and job 10. Jobs 2-7 are scheduled to be executed by resources 1-3, taking into account travel time.

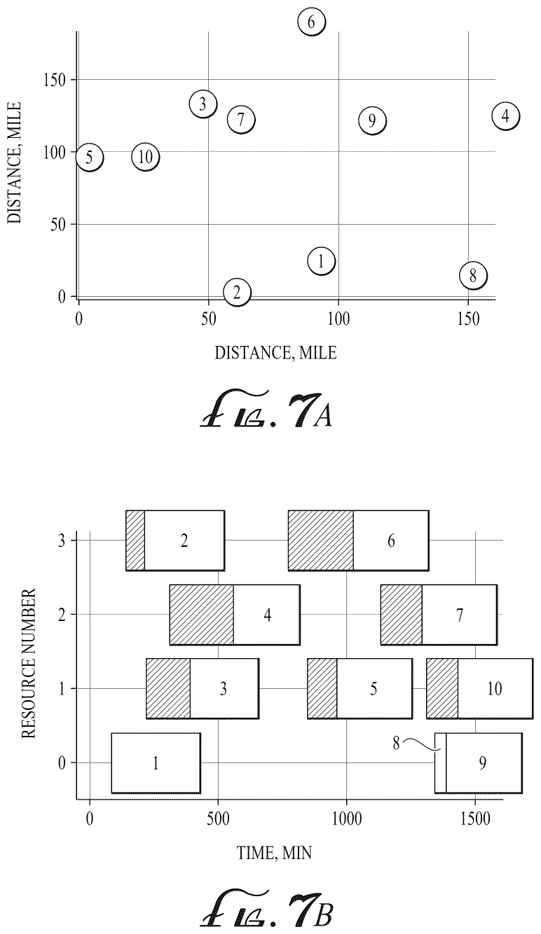

FIG. 7 shows another example in which the sequence predictor is applied to ten jobs, wherein the ten jobs are spaced over a geographical area. In this example, the allocation among the series of allocations with the lowest cost function involves three jobs being missed: job 1, job 8, and job 9. Jobs 2-7 and 10 are scheduled to be executed by resources 1-3, taking into account travel time.

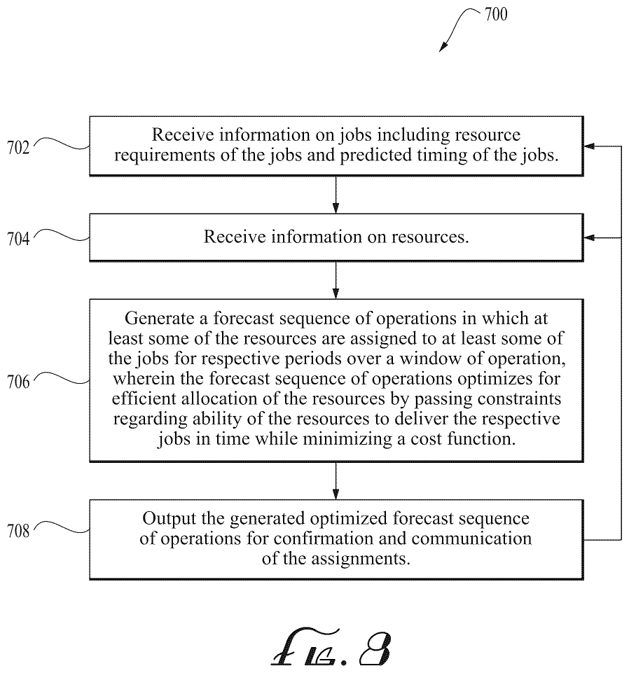

Referring to FIG. 8, a processor-implemented method for assigning resources for wellbore servicing operations may include the step 702 of receiving information on jobs including resource requirements of the jobs and predicted timing of the jobs; the step 704 of receiving information on resources; the step 706 of generating a forecast sequence of operations in which at least some of the resources are assigned to at least some of the jobs for respective periods over a window of operation, wherein the forecast sequence of operations optimizes for efficient allocation of the resources by passing constraints regarding ability of the resources to deliver the respective jobs in time while minimizing a cost function; and the step 708 of outputting the generated optimized forecast sequence of operations for confirmation and communication of the assignments. In some embodiments, the method 700 may include a loop structure (e.g., the method 700 may not be a linear scheduling process). Both job sequence changes and changes to resource availability may trigger a re-run of the optimization. For example, output from step 708 that involves a change of resource availability may trigger receiving information on resources (step 704) and/or receiving information on jobs (step 702).

The system and method of the present disclosure may exceed human ability to allocate resources by implementing computational methods. Problems of small size can be brute forced and accelerated. However, the global optimum may only be determined if all possible allocations are searched. AI driven algorithms can be used to approximate the optimal solution. Also, mixed integer linear programming (e.g., both the objective function and all the constraints are linear functions) can be used to approximate the optimal solution.

The system and method of the present disclosure may present the advantage in that current assignment decisions can made be improved. Coordinators base on their experience and state of mind in the moment. The coordinators balance a number of deciding factors and are not necessarily aware of the utilization impact of their decisions. In combination with the data model, the efficiency of assignment decisions may be made transparent and improved. The system may also be able to identify options outside the coordinator's immediate field of view. The system may combine the experience of the human coordinators and their insight into non-tangible requirements with a strictly efficiency-focused suggestion system of the forecast generator. The resulting optimized utilization may allow freeing resources for jobs not currently being serviced or adjustment of the resource pool to market requirements. That is, physically implementing the generated optimized forecast sequence of operations in the field (e.g., physically executing the assignments of resources to jobs by sending personnel, equipment and materials to jobs) may improve overall efficiency of operations as compared to the conventional art. In particular, a method of servicing a wellbore penetrating a subterranean formation which is carried out based on the forecast sequence of operations generated according to the method of the present disclosure may be more efficient (e.g., saving time and/or resources) and/or be more cost effective (e.g., reducing the overall cost of the operation) as compared with the conventional art.

### ADDITIONAL DISCLOSURE

The following are non-limiting, specific embodiments in accordance with the present disclosure:

In a first embodiment, a system for assigning resources for wellbore servicing operations comprises one or more processors configured to: receive information on jobs including resource requirements of the jobs and predicted timing of the jobs; receive information on resources; generate a forecast sequence of operations in which at least some of the resources are assigned to at least some of the jobs for respective periods over a window of operation, wherein the forecast sequence of operations optimizes for efficient allocation of the resources by passing constraints regarding ability of the resources to deliver the respective jobs in time while minimizing a cost function; and output the generated optimized forecast sequence of operations for confirmation and communication of the assignments.

A second embodiment can include the system of the first embodiment, wherein the optimizing minimizes time or distance traveled to jobs across a fleet.

A third embodiment can include the system of the first or second embodiments, further comprising a display configured to display the generated forecast sequence of operations.

A fourth embodiment can include the system of any of the first through third embodiments, wherein the cost function comprises jobs not executed and associated opportunity cost of the jobs not executed.

A fifth embodiment can include the system of any of the first through fourth embodiments, wherein the one or more processors are further configured to provide a user interface configured to receive user input for accepting or altering the forecast sequence of operations.

A sixth embodiment can include the system of any of the first through fifth embodiments, wherein the forecast sequence of operations is updated in response to either one or both of the information on the jobs and the information on the available resources being updated.

A seventh embodiment can include the system of any of the first through sixth embodiments, wherein the information on the jobs and the information on the resources are transmitted from a cloud-based telemetry data collection system for deployed resources.

An eighth embodiment can include the system of any of the first through seventh embodiments, wherein the information on the jobs comprises expected time of each job, location of each job, and requirements of each job.

A ninth embodiment can include the system of any of the first through eighth embodiments, wherein the information on the jobs comprises equipment required for each job, personnel required for each job, and materials required for each job.

A tenth embodiment can include the system of any of the first through ninth embodiments, wherein the information on the resources comprises geolocation information of the resources and status information of the resources.

An eleventh embodiment can include the system of any of the first through tenth embodiments, wherein the information on the resources comprises equipment, personnel, and material.

A twelfth embodiment can include the system of any of the first through eleventh embodiments, wherein the equipment comprises bulk storage, bulk transport, pump unit, automotive, and ancillary equipment.

A thirteenth embodiment can include the system of any of the first through twelfth embodiments, wherein the constraints comprise ability of the equipment to do the jobs, fitness of the equipment to do the jobs, ability for the equipment to arrive at the jobs in time, and ability of the equipment to finish the jobs.

A fourteenth embodiment can include the system of any of the first through thirteenth embodiments, wherein the personnel comprises one or more service leaders, one or more supervisors, one or more operators, one or more bulk operators, one or more helpers, and one or more bulk drivers.

A fifteenth embodiment can include the system of any of the first through fourteenth embodiments, wherein the constraints comprise qualification of the personnel to do the jobs, fitness of the personnel to do the jobs including regulatory rest requirements, ability of the personnel to arrive at the jobs on time, and ability of the personnel to finish the jobs.

A sixteenth embodiment can include the system of any of the first through fifteenth embodiments, wherein the material comprises type of material, quantity of material, location of material, and status of material.

A seventeenth embodiment can include the system of any of the first through sixteenth embodiments, wherein the constraints comprise whether the material is appropriate for the jobs, whether the material is of sufficient quality for the jobs, and whether the material can arrive at the jobs on time.

An eighteenth embodiment can include the system of any of the first through seventeenth embodiments, wherein the jobs comprise well service operations including drilling operations, cementing operations, fracking operations, well intervention operations, and pumping operations.

In a nineteenth embodiment, a processor-implemented method for assigning resources for wellbore servicing operations comprises receiving information on jobs including resource requirements of the jobs and predicted timing of the jobs; receiving information on resources; generating a forecast sequence of operations in which at least some of the resources are assigned to at least some of the jobs for respective periods over a window of operation, wherein the forecast sequence of operations optimizes for efficient allocation of the resources by passing constraints regarding ability of the resources to deliver the respective jobs in time while minimizing a cost function; and outputting the generated optimized forecast sequence of operations for confirmation and communication of the assignments.

A twentieth embodiment can include the method of the ninetieth embodiment, wherein the optimizing minimizes time or distance traveled to jobs across a fleet.

In a twenty-first embodiment, a method of servicing wellbores penetrating subterranean formations comprises receiving information on a plurality of jobs for servicing the wellbores (e.g., the jobs are operations to be performed in or on the wellbores), wherein the information on the plurality of jobs comprises resource requirements of the plurality of jobs (e.g., what resources are required for performing the jobs) and predicted timing of the plurality of jobs (e.g., when the jobs are required to be performed according to a schedule); receiving information on a plurality of resources (e.g., information about what resources are available and the nature of the resources); generating a forecast sequence of operations (e.g., a plan for executing the jobs using the resources) in which resources of the plurality of resources are assigned to jobs of the plurality of jobs for respective periods over a window of operation (e.g., corresponding to how far in advance operations are planned), wherein the forecast sequence of operations optimizes for efficient allocation of the resources by passing constraints regarding ability of the resources to deliver the respective jobs in time (e.g., ability of the resources to timely arrive at and/or perform the jobs) while minimizing a cost function (e.g., related to economics of the overall operations); transporting the resources to the jobs (e.g., by a vehicle) according to the generated forecast sequence of operations (e.g., according to the planned sequence of operations); and performing the jobs using the transported resources (e.g., the resources perform the jobs according to the plan).

A twenty-second embodiment can include the method of the twenty-first embodiment, wherein the resources comprise pumps, and the performing of the jobs comprises, after the transporting of the resources, placing the pumps (which have arrived at the jobs according to the generated forecast sequence of operations) in fluid communication with the wellbores, which are associated with the jobs (e.g., the jobs are to be performed on the wellbores), and pumping fluid into the wellbores using the pumps (e.g., cementing the wellbores, fracking the wellbores, and/or another operation on the wellbores).

A twenty-second embodiment can include the method of the twenty-first or twenty-second embodiments, wherein the fluid comprises any one or any combination of any two or more of drilling fluid, cementitious fluid, fracturing fluid, remediation fluid, acidizing fluid, sweeping fluid, and carbon dioxide.

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Disclosure of a singular element should be understood to provide support for a plurality of the element. It is contemplated that elements of the present disclosure may be duplicated in any suitable quantity.

Use of broader terms such as comprises, includes, having, etc. should be understood to provide support for narrower terms such as consisting of, consisting essentially of, comprised substantially of, etc. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” does not require selection of only one element. Thus, the phrase “A or B” is satisfied by either one or both elements from the set {A, B}, including multiples of either element; and the phrase “A, B, or C” is satisfied by any element from the set {A, B, C} or any combination thereof, including multiples of any element. A clause that recites “A, B, or C” can be infringed with only one of the listed items, multiple of the listed items, and one or more of the items in the list and another item not listed.

As used herein, the article “a” means “one or more.” As used herein, the article “an” means “one or more.” As used herein, the article “the” when referring to a singular noun means “the one or more.” Thus, the phrase “an element” means “one or more elements;” and the phrase “the element” means “the one or more elements.”

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A system for assigning resources for wellbore servicing operations, comprising:
one or more processors configured to:
receive information on jobs including resource requirements of the jobs and predicted timing of the jobs;
receive information on resources;
generate a forecast sequence of operations in which at least some of the resources are assigned to at least some of the jobs for respective periods over a window of operation, wherein the forecast sequence of operations optimizes for efficient allocation of the resources by passing constraints regarding ability of the resources to deliver the respective jobs in time while minimizing a cost function; and
output the generated optimized forecast sequence of operations for confirmation and communication of the assignments.

2. The system of claim 1, wherein the cost function comprises jobs not executed, associated opportunity cost of the jobs not executed, costs associated with each job to be performed, and overall profitability.

3. The system of claim 1, further comprising a display configured to display the generated forecast sequence of operations.

4. The system of claim 2, wherein the optimizing minimizes number of jobs missed and costs associated with time.

5. The system of claim 1, wherein the one or more processors are further configured to provide a user interface configured to receive user input for accepting or altering the forecast sequence of operations.

6. The system of claim 1, wherein the forecast sequence of operations is updated in response to either one or both of the information on the jobs and the information on the available resources being updated.

7. The system of claim 1, wherein the information on the jobs and the information on the resources are transmitted from a cloud-based telemetry data collection system for deployed resources.

8. The system of claim 1, wherein the information on the jobs comprises expected time of each job, location of each job, and requirements of each job.

9. The system of claim 1, wherein the information on the jobs comprises equipment required for each job, personnel required for each job, and materials required for each job.

10. The system of claim 1, wherein the information on the resources comprises geolocation information of the resources and status information of the resources.

11. The system of claim 1, wherein the information on the resources comprises equipment, personnel, and material.

12. The system of claim 11, wherein the equipment comprises bulk storage, bulk transport, pump unit, automotive, and ancillary equipment.

13. The system of claim 11, wherein the constraints comprise ability of the equipment to do the jobs, fitness of the equipment to do the jobs, ability for the equipment to arrive at the jobs in time, and ability of the equipment to finish the jobs.

14. The system of claim 11, wherein the personnel comprises one or more service leaders, one or more supervisors, one or more operators, one or more bulk operators, one or more helpers, and one or more bulk drivers.

15. The system of claim 11, wherein the constraints comprise qualification of the personnel to do the jobs, fitness of the personnel to do the jobs including regulatory rest requirements, ability for the personnel to arrive at the jobs on time, and ability of the personnel to finish the jobs.

16. The system of claim 11, wherein the material comprises type of material, quantity of material, location of material, and status of material.

17. The system of claim 11, wherein the constraints comprise whether the material is appropriate for the jobs, whether the material is of sufficient quality for the jobs, and whether the material can arrive at the jobs on time.

18. The system of claim 1, wherein the jobs comprise well service operations including drilling operations, cementing operations, fracking operations, well intervention operations, and pumping operations.

19. The system of claim 1, wherein the one or more processors are further configured to generate the forecast sequence of operations by generating a series of allocations in which at least some of the resources are assigned to at least some of the jobs using a mixed integer model for optimization, and choosing an allocation from the series of allocations that passes the constraints and has a lowest value for the cost function as the forecast sequence of operations.

20. The system of claim 19, wherein the one or more processors are further configured to generate a forecast using a machine learning model, and use the forecast as an input to the mixed integer model.

21. A processor-implemented method for assigning resources for wellbore servicing operations, comprising:
receiving information on jobs including resource requirements of the jobs and predicted timing of the jobs;
receiving information on resources;
generating a forecast sequence of operations in which at least some of the resources are assigned to at least some of the jobs for respective periods over a window of operation, wherein the forecast sequence of operations optimizes for efficient allocation of the resources by passing constraints regarding ability of the resources to deliver the respective jobs in time while minimizing a cost function; and
outputting the generated optimized forecast sequence of operations for confirmation and communication of the assignments.

22. The method of claim 21, wherein the optimizing minimizes time or distance traveled to jobs across a fleet.

23. A method of servicing wellbores penetrating subterranean formations, comprising:
receiving information on a plurality of jobs for servicing the wellbores, wherein the information on the plurality of jobs comprises resource requirements of the plurality of jobs and predicted timing of the plurality of jobs;
receiving information on a plurality of resources;
generating a forecast sequence of operations in which resources of the plurality of resources are assigned to jobs of the plurality of jobs for respective periods over a window of operation, wherein the forecast sequence of operations optimizes for efficient allocation of the resources by passing constraints regarding ability of the resources to deliver the respective jobs in time while minimizing a cost function;
transporting the resources to the jobs according to the generated forecast sequence of operations; and
performing the jobs using the transported resources.

24. The method of claim 23, wherein
the resources comprise pumps, and
the performing of the jobs comprises, after the transporting of the resources, placing the pumps in fluid communication with the wellbores, which are associated with the jobs, and pumping fluid into the wellbores using the pumps.

25. The method of claim 23, wherein the fluid comprises any one or any combination of any two or more of drilling fluid, cementitious fluid, fracturing fluid, remediation fluid, acidizing fluid, sweeping fluid, and carbon dioxide.
